(19) United States
(12) Patent Application Publication
(10) Pub. No.: US 2006/0020610 A1
(43) Pub. Date: Jan. 26, 2006

(54) Attribute-collection approach to non-sequential, multiple-hierarchy databases

(76) Inventors: Chris Herrick, Somerville, MA (US); Aaron Abend, Carlisle, MA (US)

Correspondence Address: Mark J. Pandiscio;Pandiscio & Pandiscio, P.C., 470 Totten Pond Road, Waltham, MA, 02451-1914, US

(21) Appl. No.: 11/188,253

(22) Filed: Jul. 22, 2005

Related U.S. Application Data
(60) Provisional application No. 60/590,212, filed on Jul. 22, 2004.

(51) Int. Cl. G06F 7/00; G06F 17/00

(52) U.S. Cl. 707/100

(57) ABSTRACT

A method for organizing a plurality of items, comprising: creating an item table comprising (i) a list of the items, and (ii) a unique item ID associated with each item; creating an attribute table comprising (i) a list of the attributes associated with one or more of the items, and (ii) a unique attribute ID associated with each attribute; for each item, identifying the set of attributes associated with that item; creating an index table comprising (i) a list of each unique set of attributes previously identified, and (ii) a unique index ID associated with each such unique set of attributes; and creating an item-to-index table comprising (i) a list of each item, and (ii) a unique index ID associated with that item. A database system, comprising: a plurality of items to be stored in the database system; an item table comprising (i) a list of the items, and (ii) a unique item ID associated with each item; an attribute table comprising (i) a list of the attributes associated with one or more of the items, and (ii) a unique attribute ID associated with each attribute; an index table comprising (i) a list of each unique set of attributes associated with the items, wherein each member of that list is associated with at least one item, and (ii) a unique index ID associated with each such unique set of attributes; and an item-to-index table comprising (i) a list of each item, and (ii) a unique index ID associated with that item.

### REFERENCE TO PENDING PRIOR PATENT APPLICATION

This patent application claims benefit of pending prior U.S. Provisional Patent Application Ser. No. 60/590,212, filed Jul. 22, 2004 by Chris Herrick et al. for AN ATTRIBUTE-INDEX APPROACH TO NON-SEQUENTIAL, MULTIPLE-HIERARCHY DATABASES (Attorney's Docket No. VIAPOINT-1 PROV).

The above-identified patent application is hereby incorporated herein by reference.

### BACKGROUND OF THE INVENTION

One of the mechanisms that computer users have for managing information is the “folder”. Folders are used in many programs to accomplish the following:
To organize documents, spreadsheets, and other “items” according to their content and meaning
To find items quickly through navigation, starting with a general concept and narrowing the concept down one level at a time

This function is provided most clearly by the Folders in Microsoft's Windows Operating System.

Microsoft's Folders have 3 important limitations:
1. An item can only appear in one place, so you have to know exactly where it is to navigate to it through Folders.
2. To see items below a folder, you have to go into every subfolder one at a time (you can do a “search” but that is a different program that has its own interface and limitations, and you lose the ability to navigate by folders at that point).
3. There is only one hierarchy, so you cannot have one hierarchy that is organized by “Industry, Company, Contact” and another organized “Business Line, Product Line, Product”.

### SUMMARY OF THE INVENTION

Viapoint's Organizer is a product that offers the familiar interface of File Explorer folders without these limitations. The technology used to accomplish this is described in this paper.

The Viapoint Technology uses a unique, innovative database structure that offers the following features that are not possible with traditional hierarchic database representations:
1. The mechanism allows any object to appear in more than one hierarchy
2. From any point in the hierarchy, it is possible to identify all members of the node without navigating through the remainder of the hierarchy, resulting in improved time performance when doing a “show all”
3. A hierarchy can be represented in any order and still find the appropriate members-Company-Contact or contact-company.
4. The mechanism avoids storing a separate record for each node-item relationship, saving from 30 to 60 percent of the space a traditional approach would use, and thereby improving performance as well.
5. A hash code mechanism is used to improve performance

The database has 7 tables with only the minimal number of columns needed to accomplish these purposes.

In one preferred form of the invention, there is provided a method for organizing a plurality of items, comprising:
creating an item table comprising (i) a list of the items, and (ii) a unique item ID associated with each item;
creating an attribute table comprising (i) a list of the attributes associated with one or more of the items, and (ii) a unique attribute ID associated with each attribute;
for each item, identifying the set of attributes associated with that item;
creating an index table comprising (i) a list of each unique set of attributes previously identified, and (ii) a unique index ID associated with each such unique set of attributes; and
creating an item-to-index table comprising (i) a list of each item, and (ii) a unique index ID associated with that item.

In another preferred form of the invention, there is provided a database system, comprising:
a plurality of items to be stored in the database system;
an item table comprising (i) a list of the items, and (ii) a unique item ID associated with each item;
an attribute table comprising (i) a list of the attributes associated with one or more of the items, and (ii) a unique attribute ID associated with each attribute;
an index table comprising (i) a list of each unique set of attributes associated with the items, wherein each member of that list is associated with at least one item, and (ii) a unique index ID associated with each such unique set of attributes; and
an item-to-index table comprising (i) a list of each item, and (ii) a unique index ID associated with that item.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts, and further wherein:

FIGS. 1-22 are a series of screen shots which illustrate one preferred implementation of the present invention.

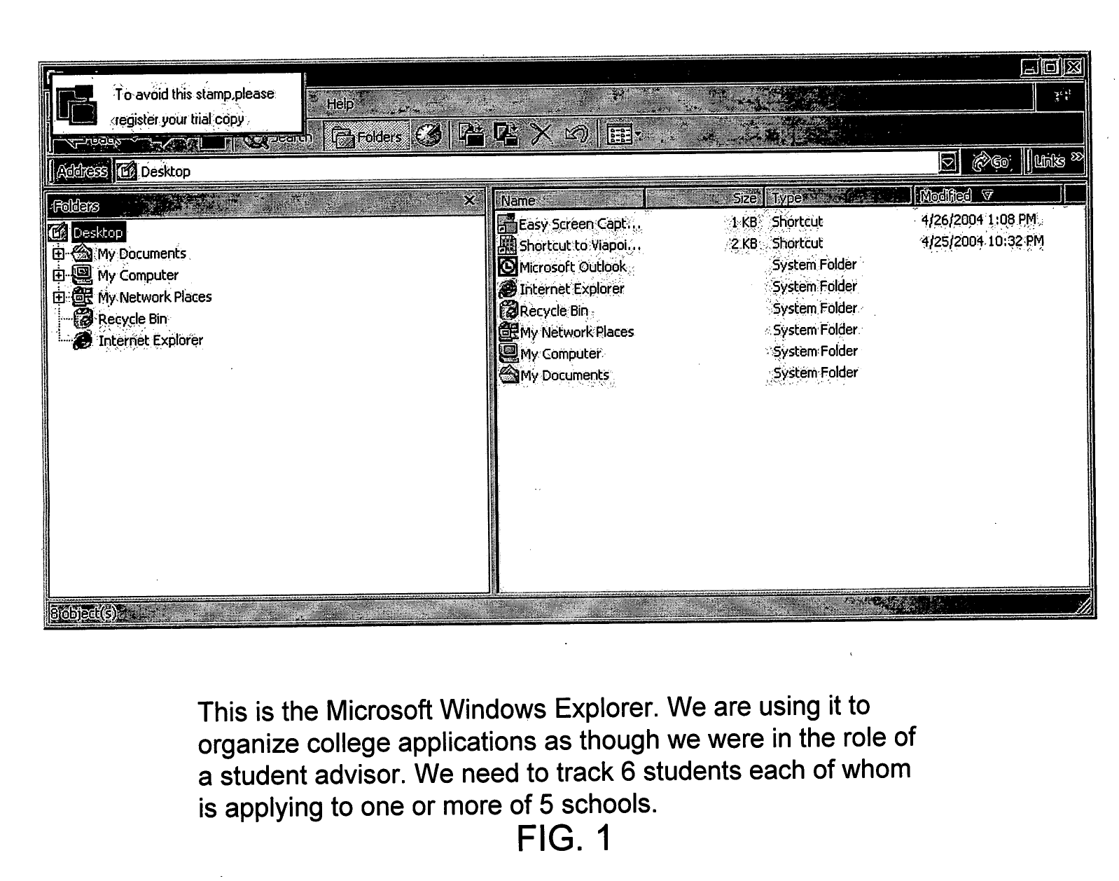

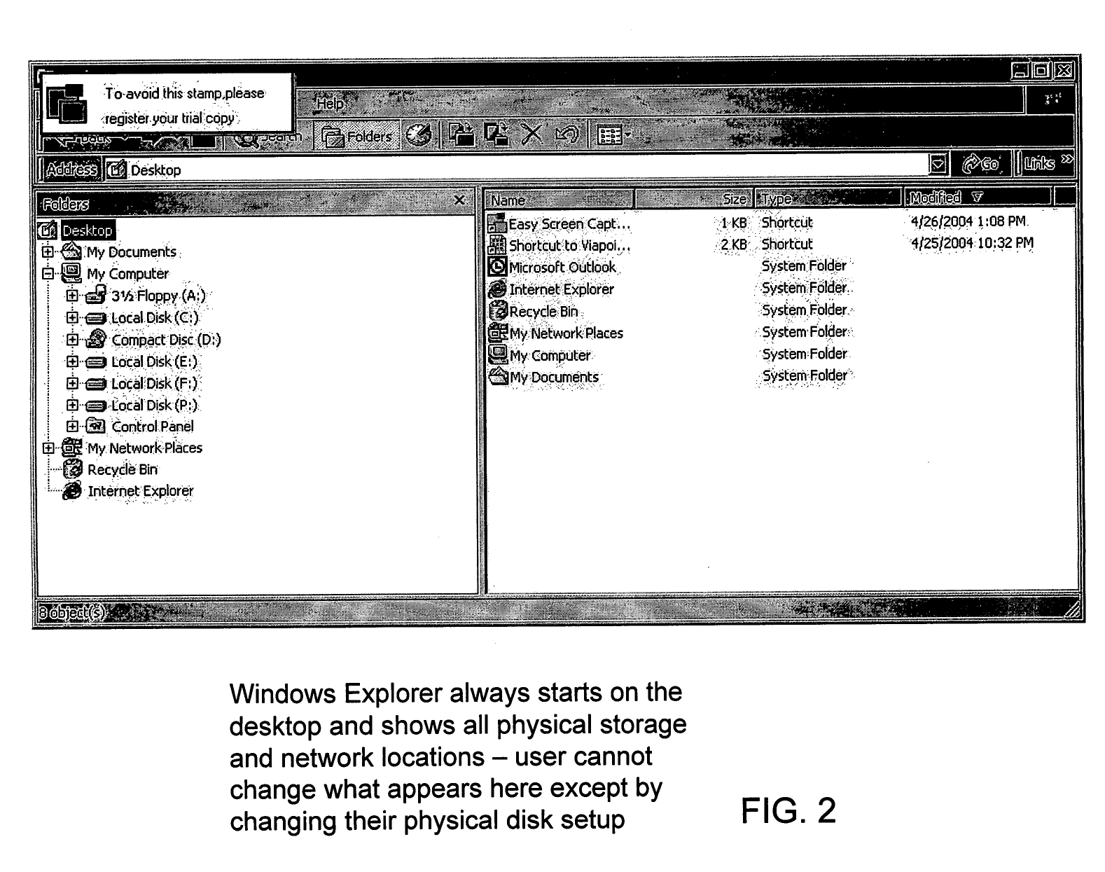

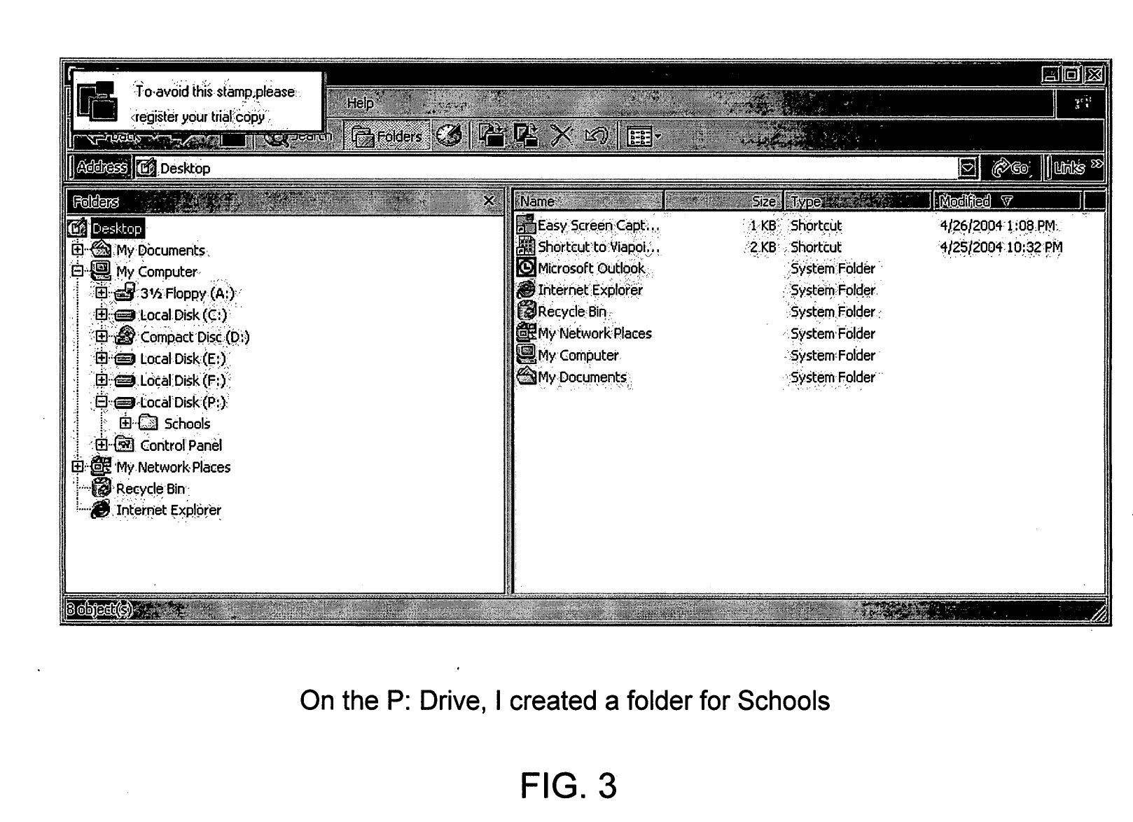

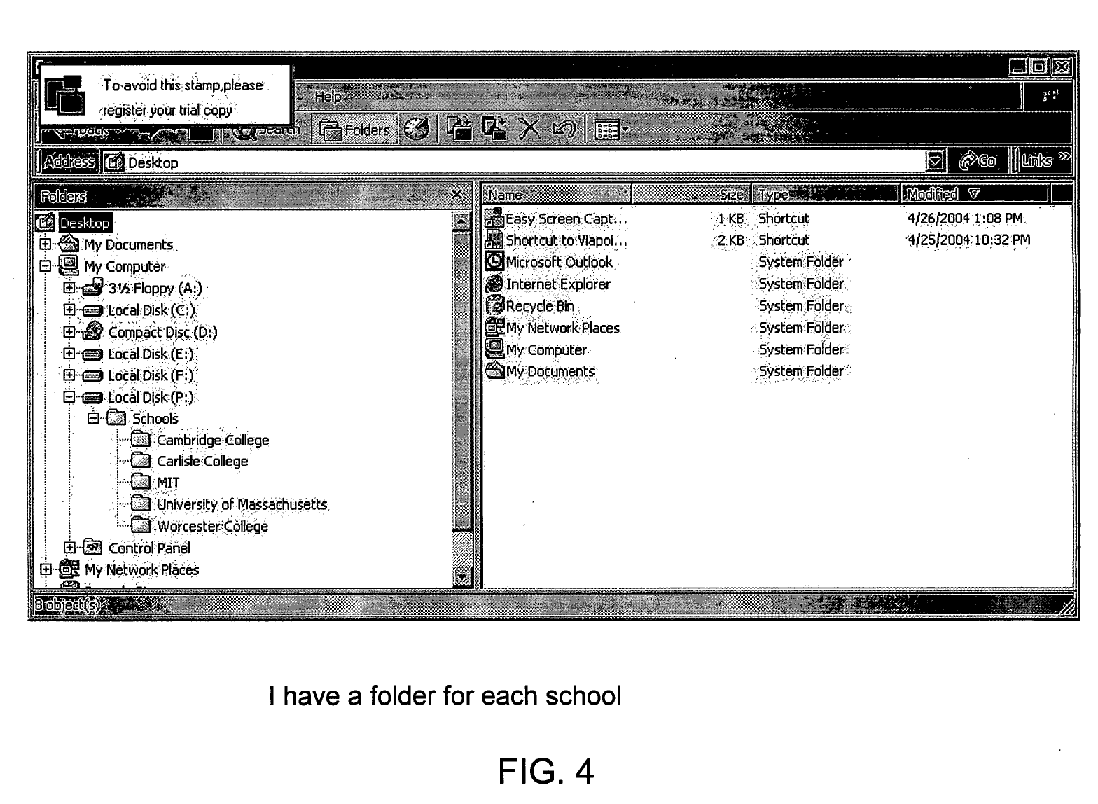

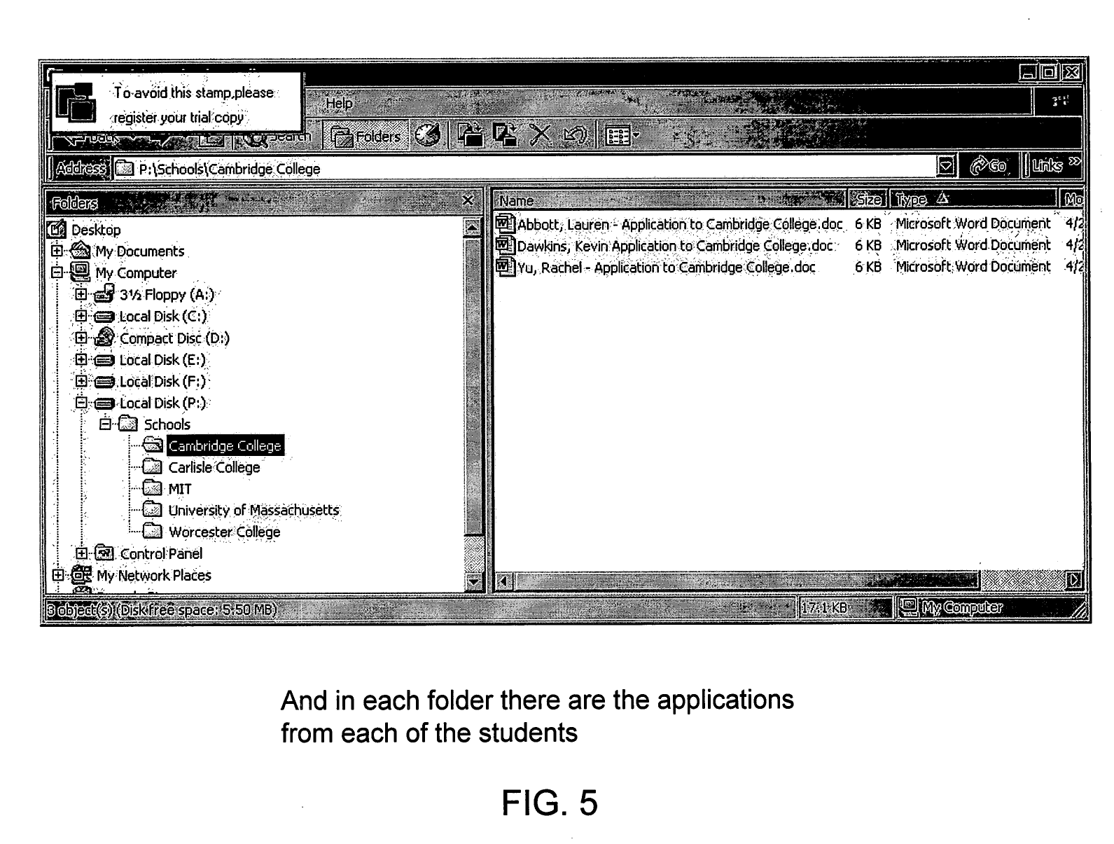

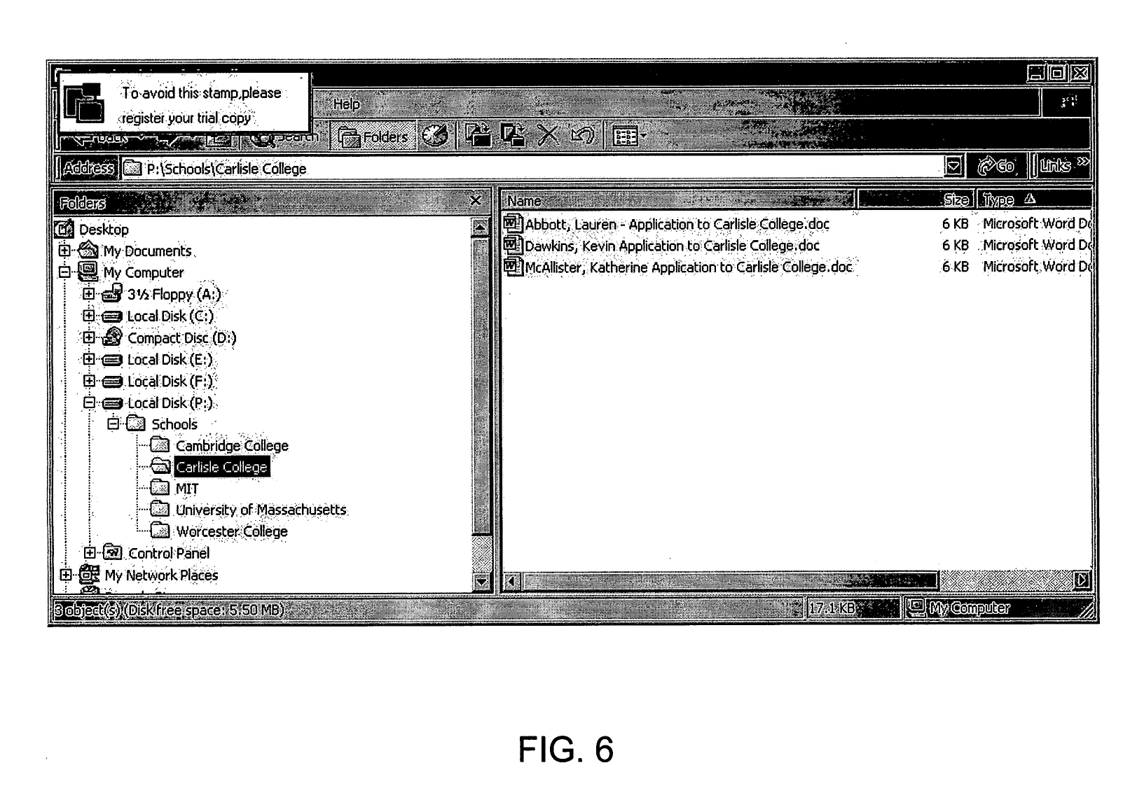

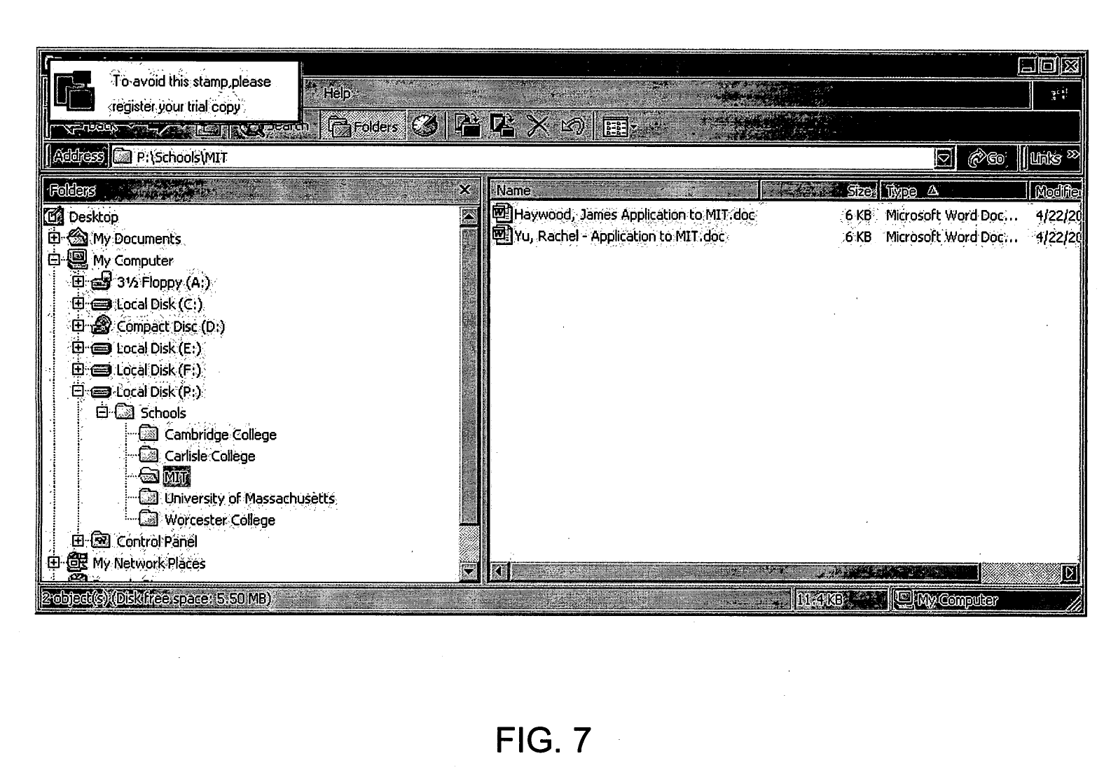

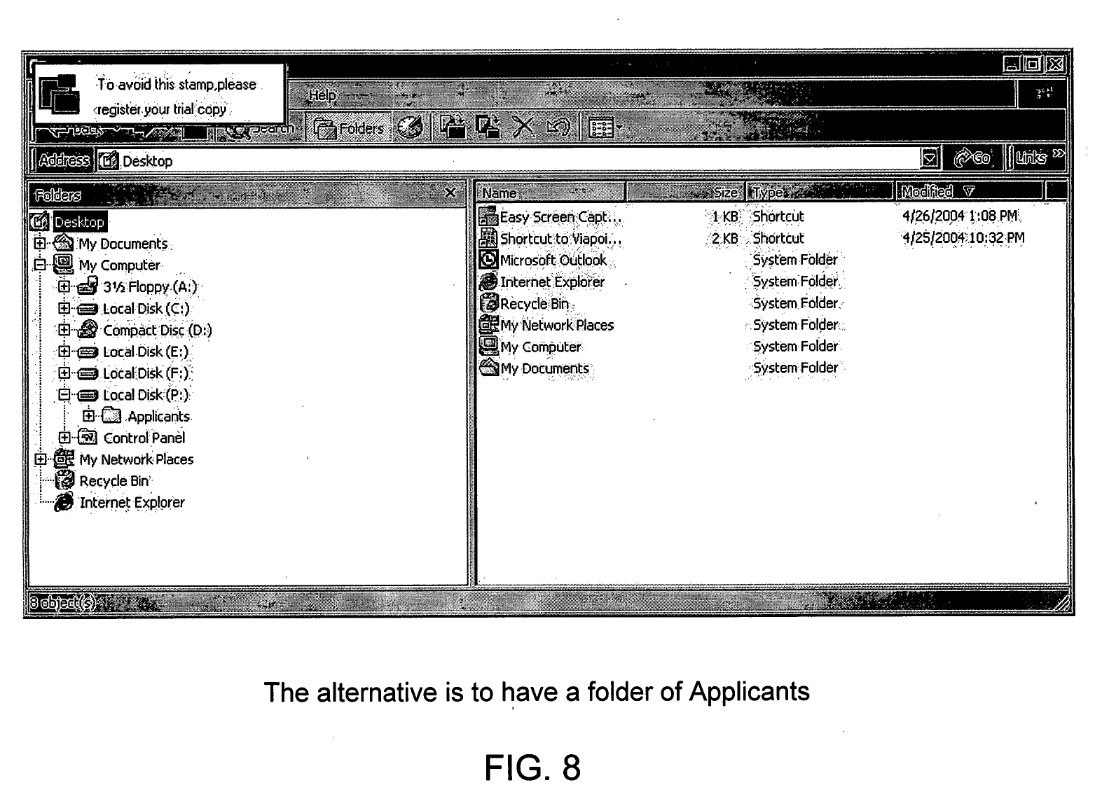

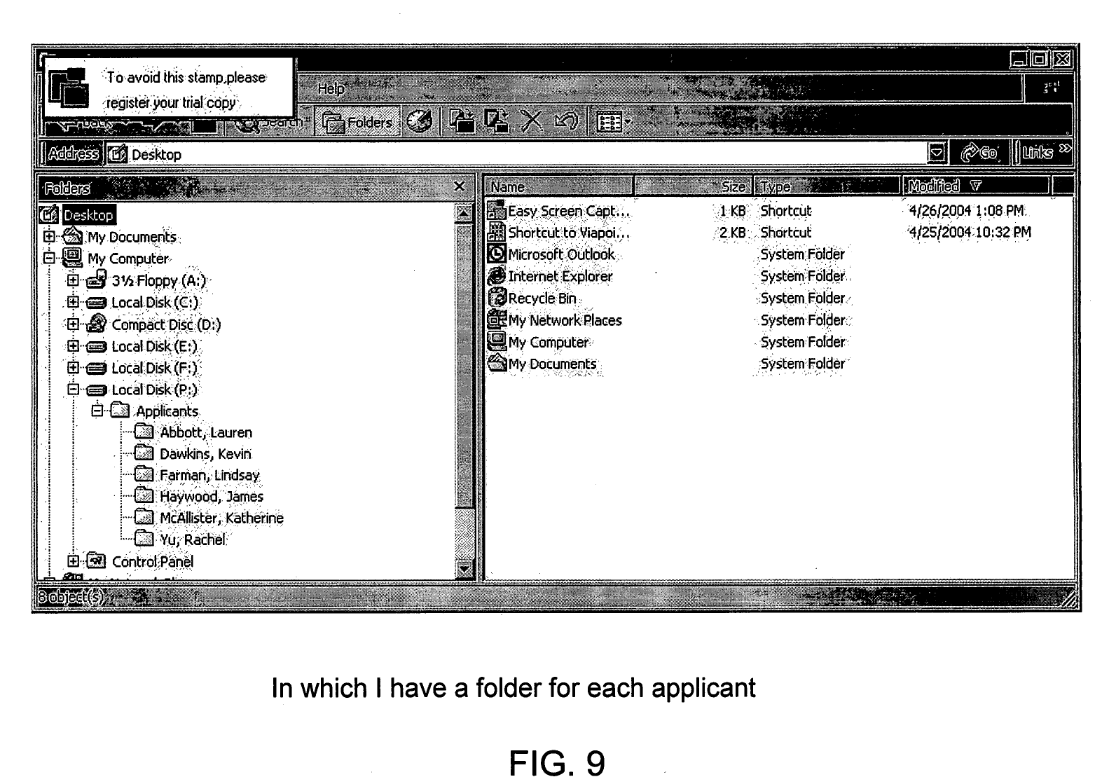

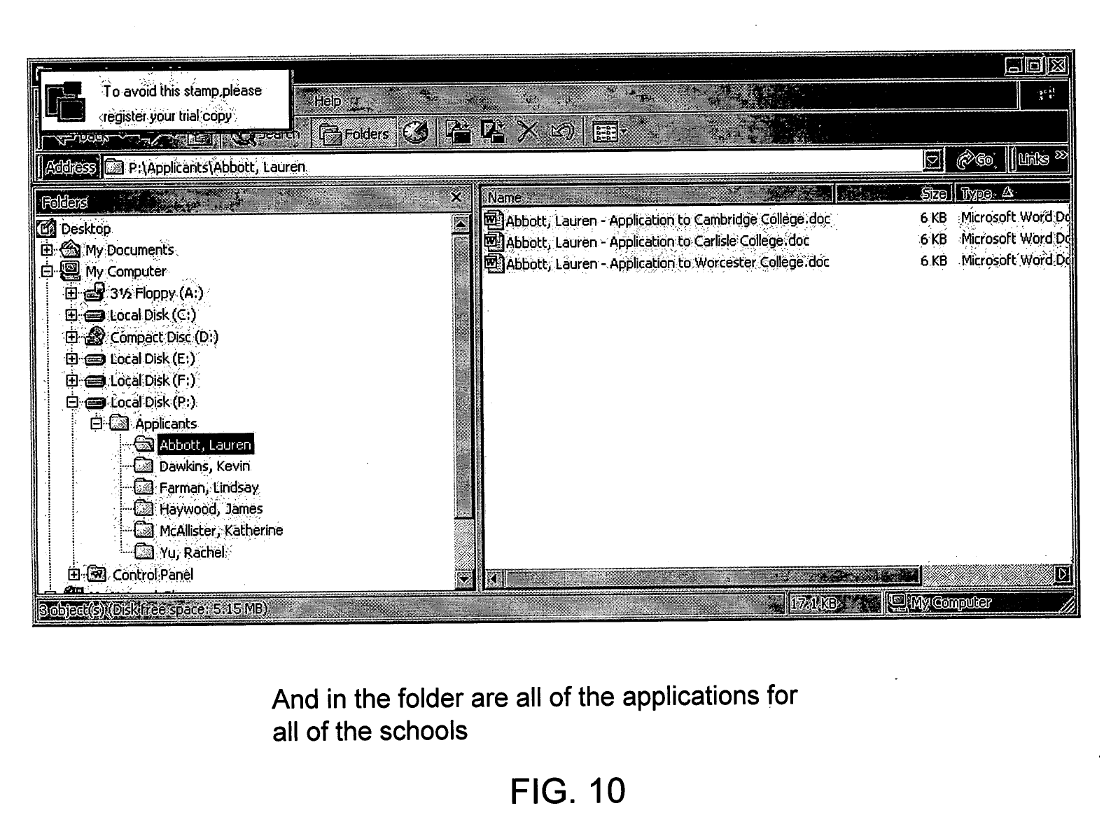

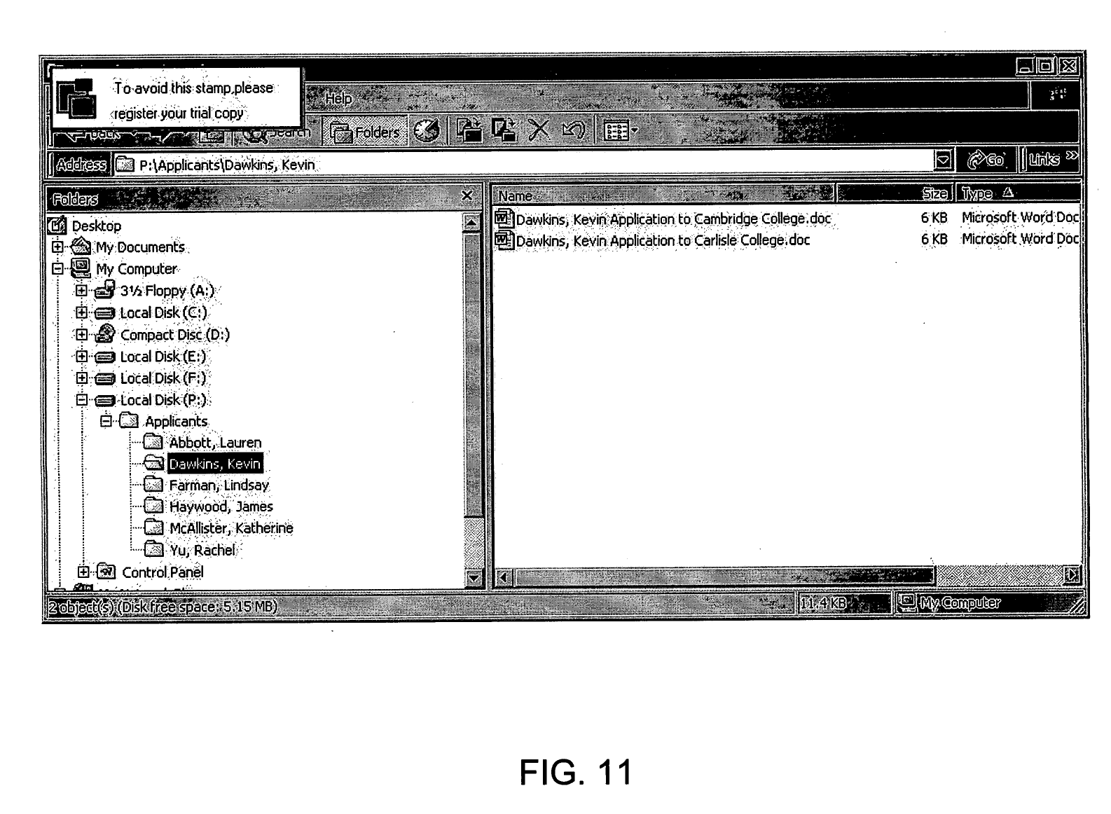

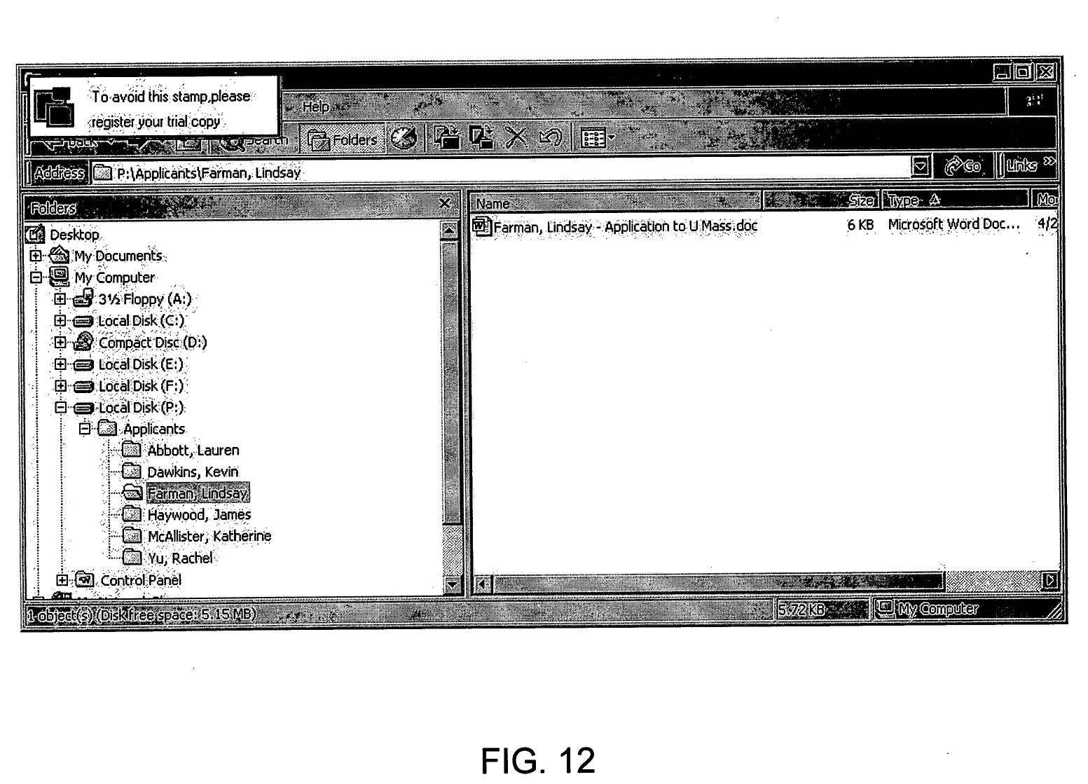

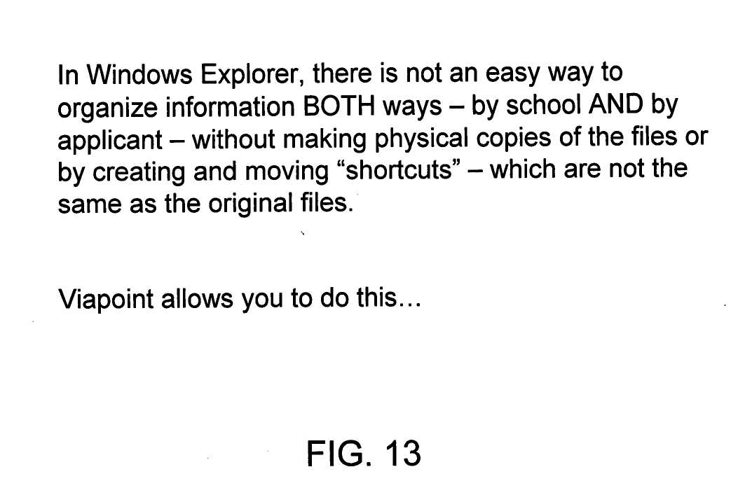

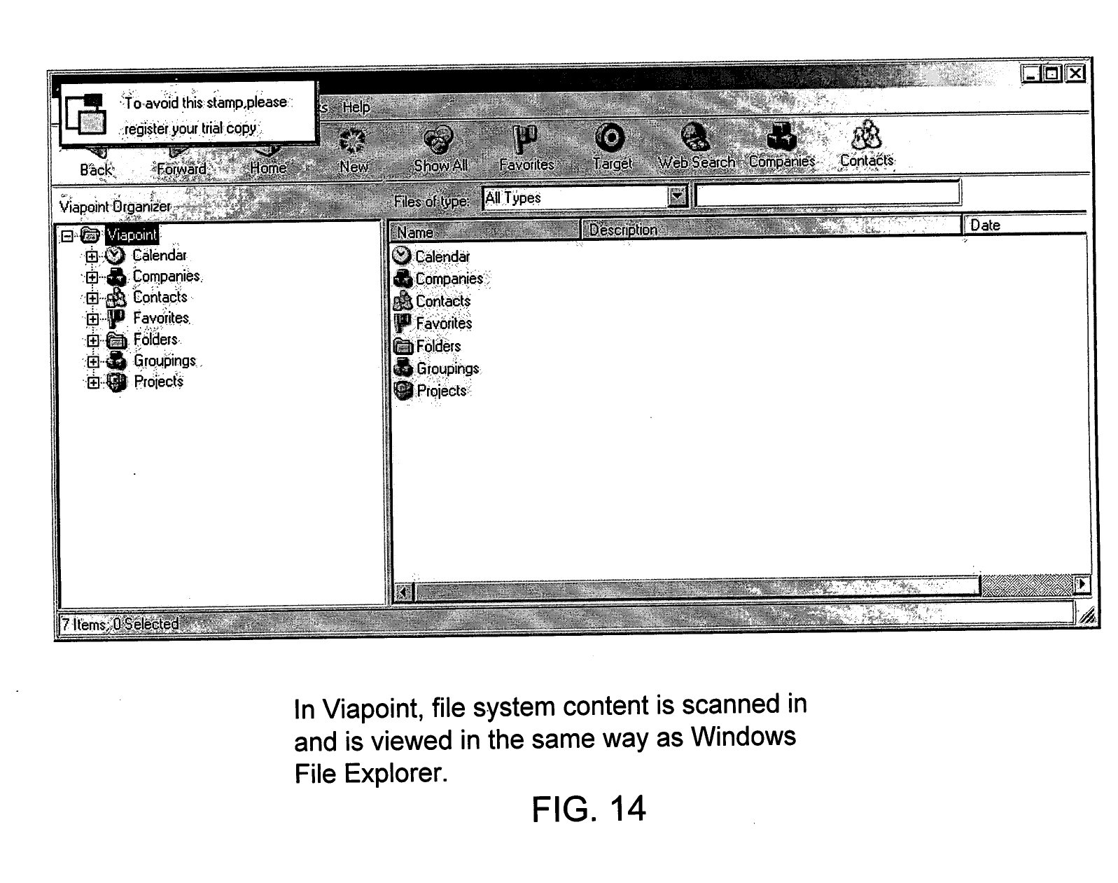

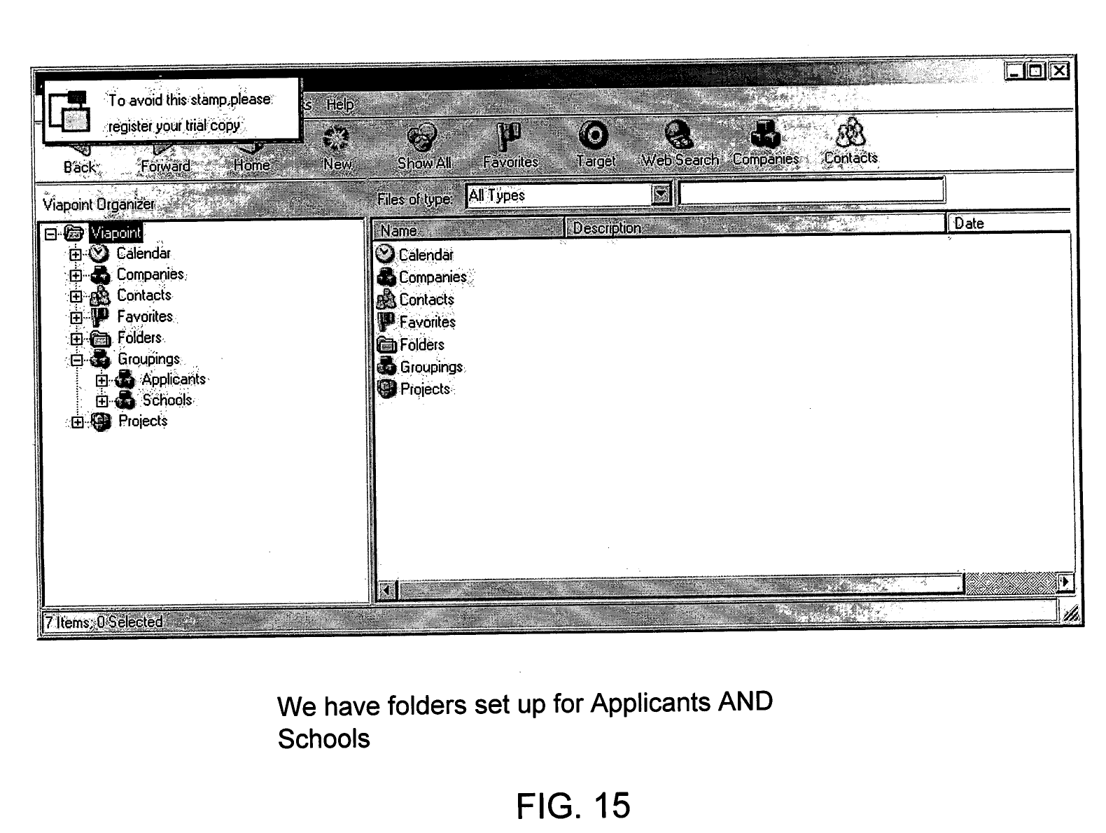

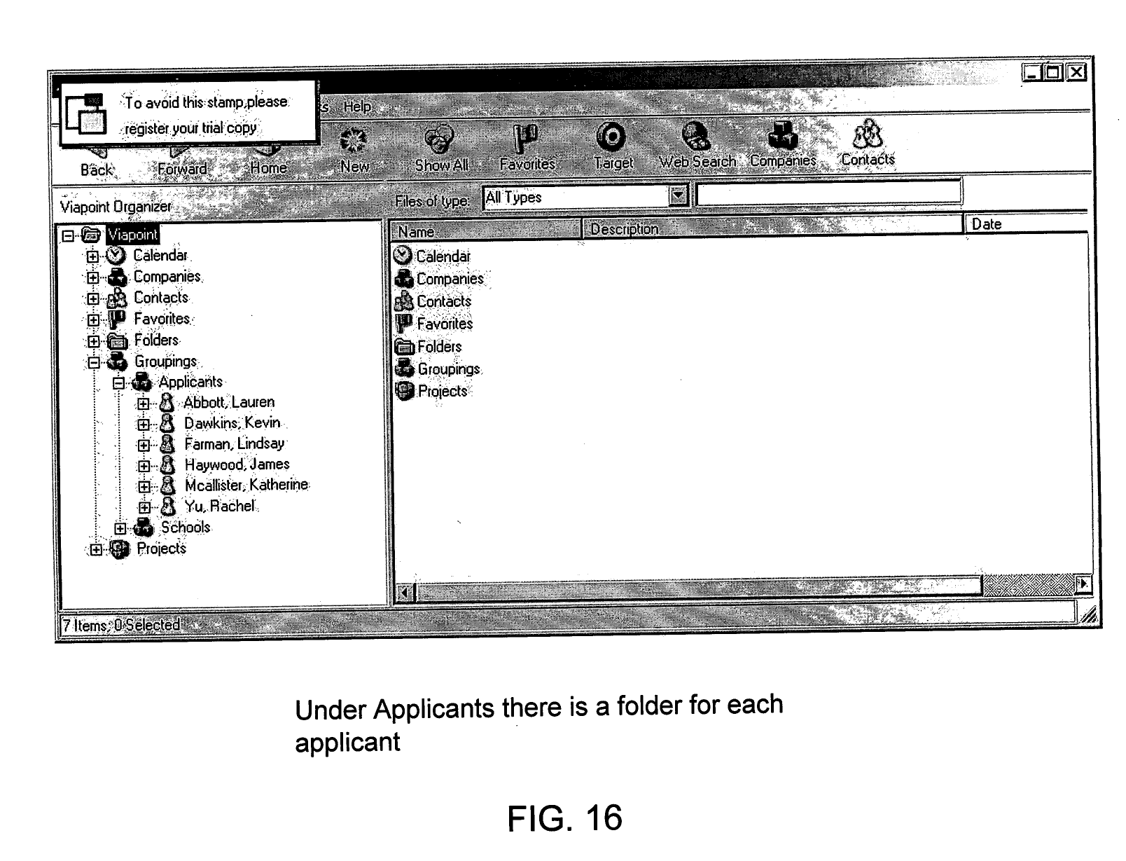

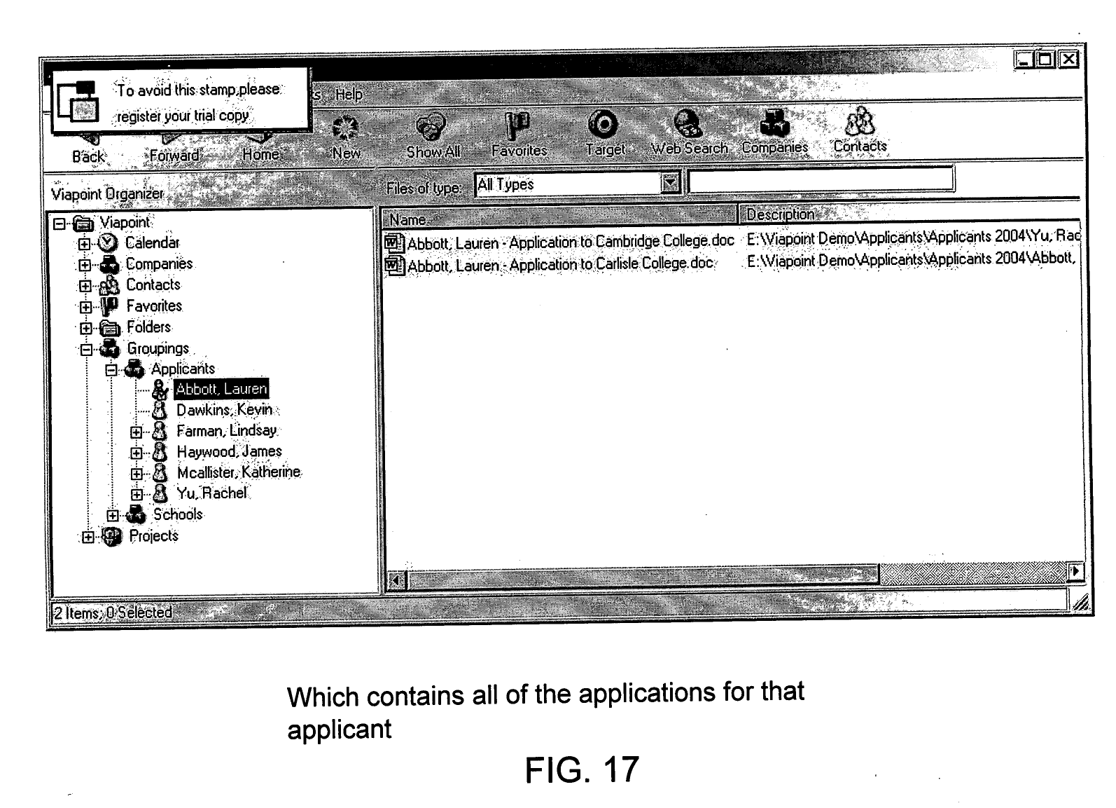

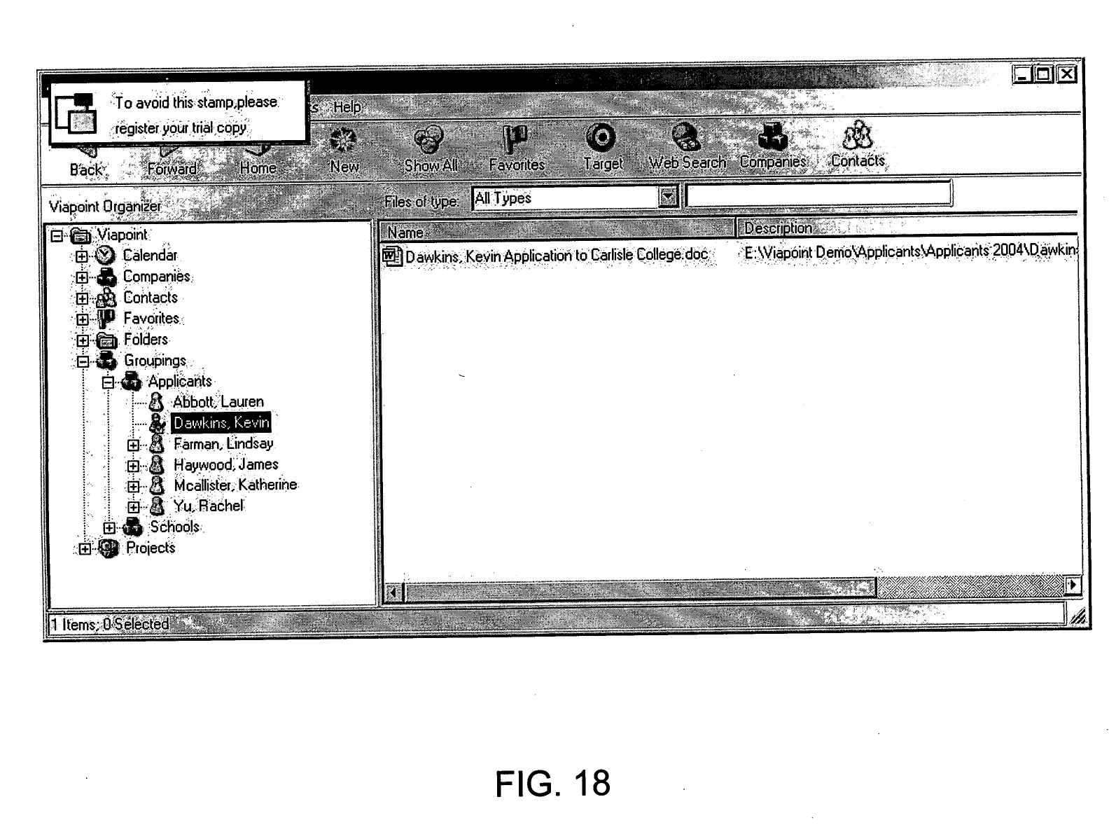

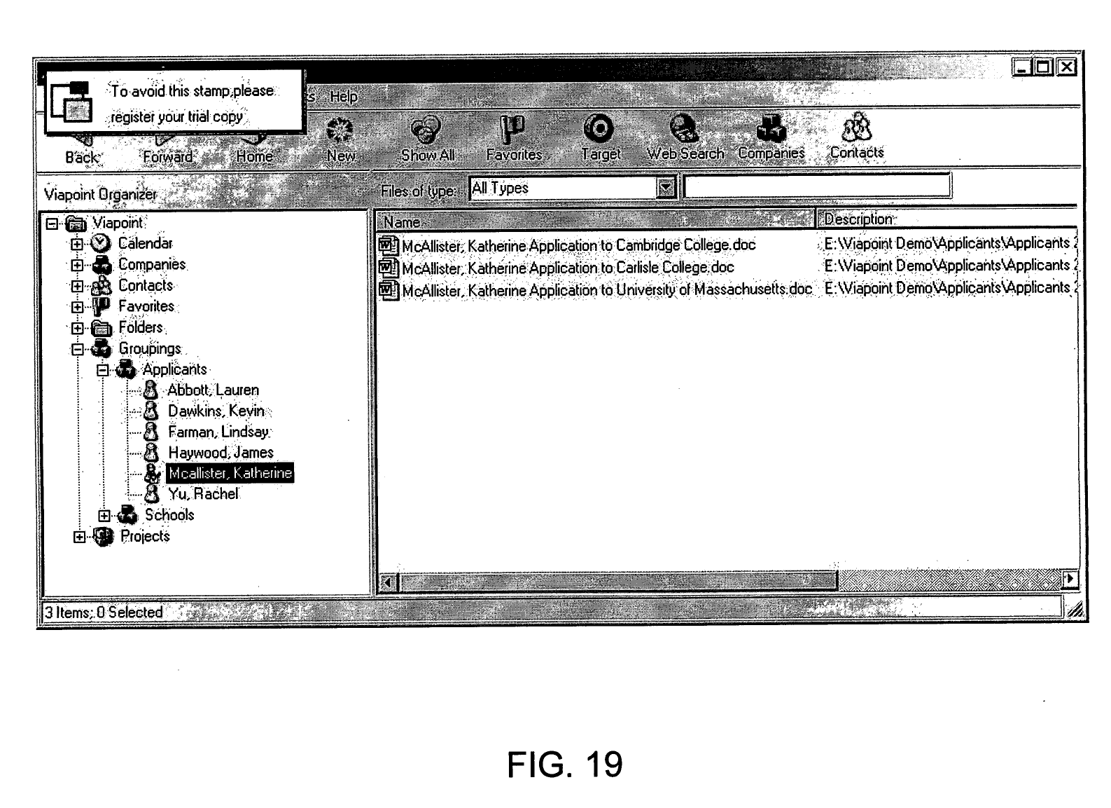

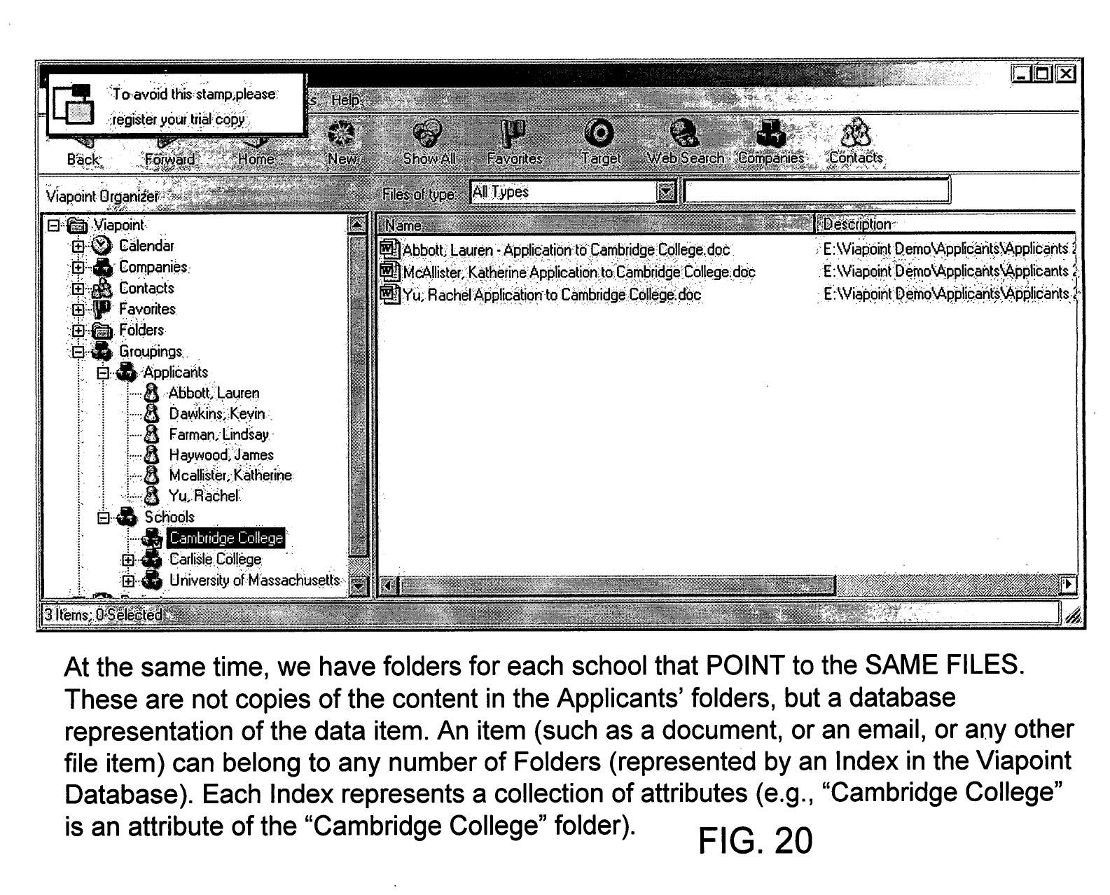

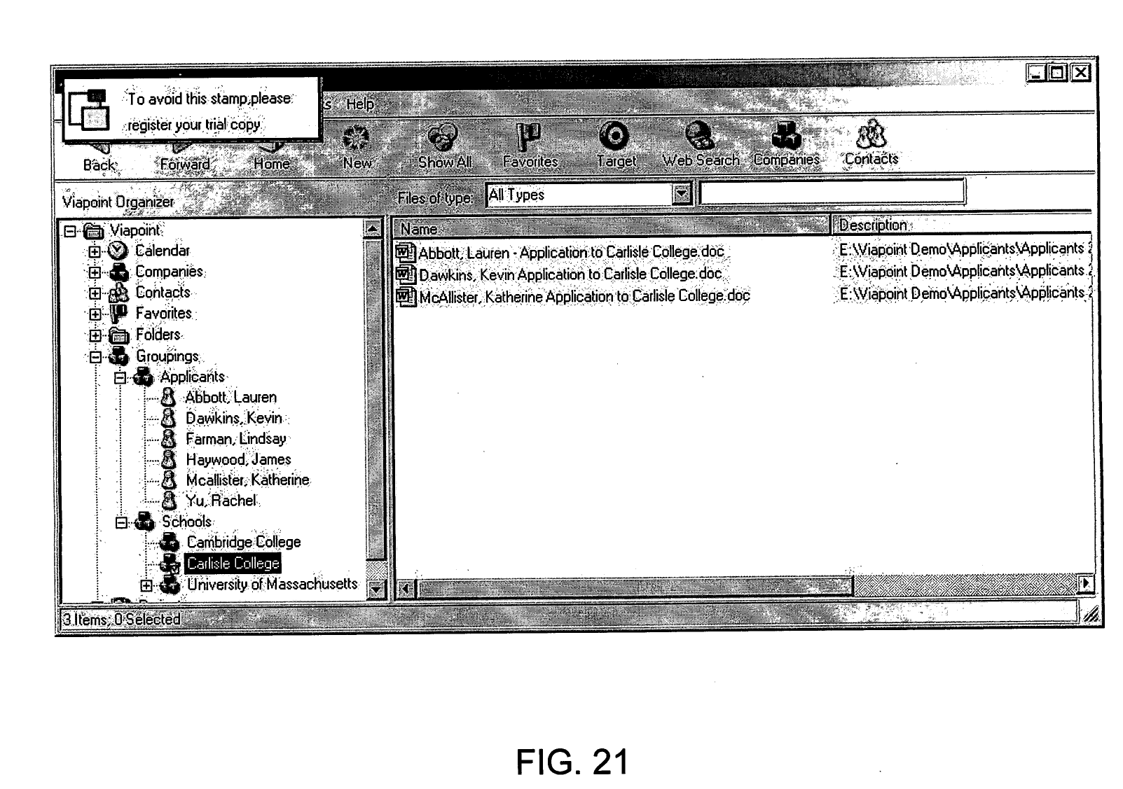

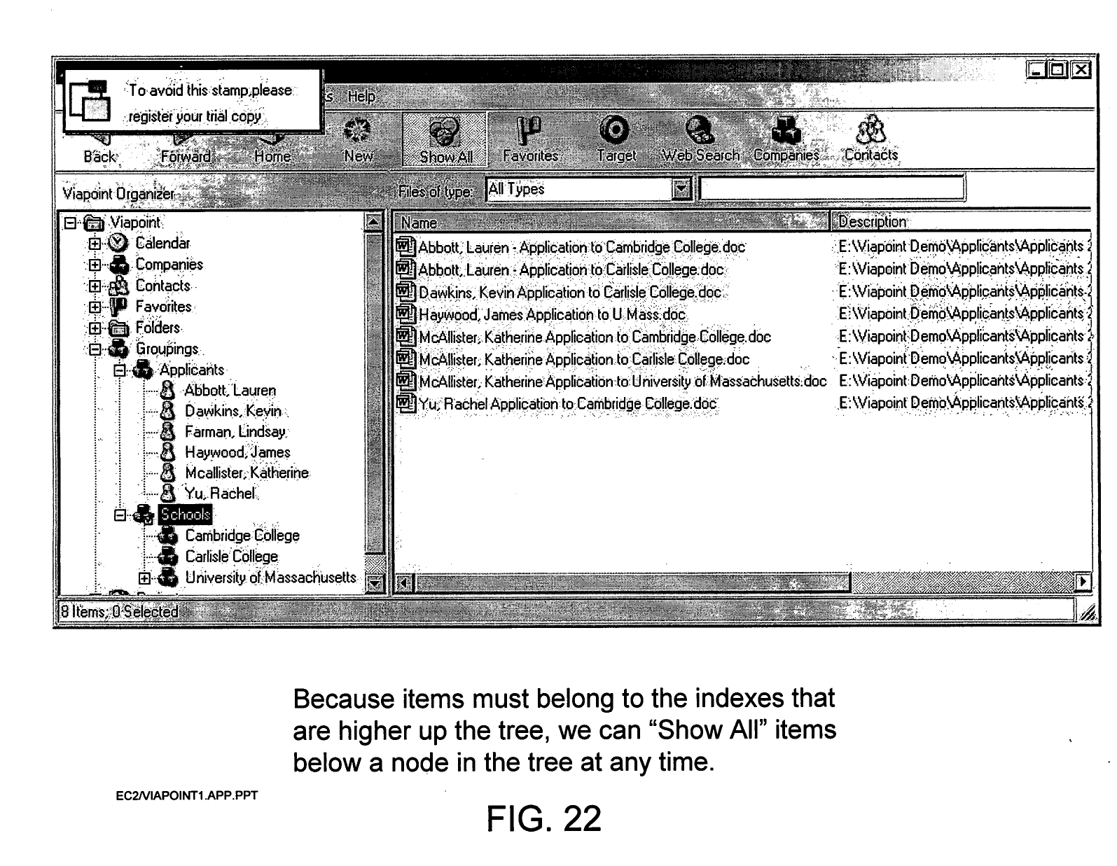

### DETAILED DESCRIPTION OF THE PREFERRED EMBODIMENTS

### Definitions

| | |
|---|---|
| Hierarchy | An organizational structure, like an organizational |
| | chart, where nodes are connected to other nodes |
| Node | A single location in a hierarchy |
| Multiple Hierarchy | A situation where items can exist in more than |
| | one hierarchy. For example, a document written |
| | about a Widget product to John Smith at XYZ |
| | corporation could be stored in a Product hierarchy |
| | and a Contact hierarchy |
| Sequential Hierarchy | A hierarchy that exists in one order only. For |
| | example, an organization that shows Company |
| | with Contacts under company is a sequential |
| | hierarchy. In a sequential hierarchy, the user |
| | cannot choose to start with Contact and show |
| | Companies. |

### Data Pointer Architectures

Viapoint allows users to access items (files, emails, and other types of computer content) even though these items are not themselves stored in the Viapoint database. What Viapoint stores are the locations of those items (also referred to as pointers). The technology Viapoint seeks to patent is the way Viapoint uses the database to manage these pointers.

Every database approach to this problem has a table that contains the location of the item (the pointer) and information about the item that the software needs in order to present it to the user in a useful way—also known as metadata. The following is a description of these other approaches so that the improvements that the Viapoint approach offers can be better understood.

Note that it is possible to store data outside of the database itself using, for example, XML files. Viapoint's claim has to do with the structure and use of these data, and not with their specific location. When we refer to a database “table”, we are including any software structure that contains one or more rows of data with one or more columns.

### Design 1: Sequential Non-Hierarchic List

In the most obvious approach, one table would contain the metadata and the location.

Item Table

itemID
itemName
itemType

In this case, the software could present a simple list of all items.

### Design 2: Simple Sequential Hierarchy

If the program wanted to present a hierarchy of folders, like Microsoft Windows Explorer, the metadata would have to include the name of the folder to which the item belonged, and there would have to be a table of folders that included the “parent” folder for each folder. This two table design would offer a single-hierarchy, sequential access to items since there would only be one parent per folder and the parent-child relationship would be sequential—the only way to identify the shape of the hierarchy would be to look at the single parent in the folder table and go to that folder. (Note: in the picture, new elements are shown in italics):

Item Table

itemID
itemName
itemType
   Folder Table
folderID
FolderName

### Design 3: Sequential Multiple Hierarchy

By extending the Folders table, it is relatively easy to have a number of hierarchies stored in the Folders table. While it would be possible to represent all possible sequences in the Folders table, we do not regard this approach as non-sequential, since it does not support non-sequential access without storing a tremendous amount of data. A viable non-sequential hierarchy cannot rely on fixed relationships between folders.

Item Table

itemID
itemName
itemType
   Folder Table
hierarchy ID
folderID
FolderName

### Design 4: Non-Sequential Multiple Hierarchy

An even more sophisticated approach is to have 3 tables:
1. A table of Items, where each file or email items is given a unique ID
2. A table of folders, where each folder is given a unique ID
3. A table that matches each folder to each item
   Item Table
itemID
itemName
itemType
   Folder Table
folderID
FolderName
   Folder_Item Table
folderID
itemID

This approach would allow an item to be associated with more than one folder, and the access could be non-sequential. In other words, it would be possible to build a hierarchy that started with the “Company” folder and show a set of “Contact” folders for each contact related to the company, but it would also be possible to build the hierarchy the other way, starting with the “Contact” folder and showing the “Company” folders associated with that contact (for example, a sales person would be associated with his own company as an employee and as the sales representative for each customer company in the database).

This what Viapoint calls a Non-sequential Multiple-Hierarchy database. Viapoint uses a different approach to accomplishing this same result that uses fewer records and is faster than this design just described.

### Design 5: An Attribute-Collection Approach to Non-Sequential Multiple Hierarchy

Viapoint's approach uses 4 main tables:
Table 1. Attributes, where each folder name that can appear in the hierarchy is given a unique ID
Table 2. AttributeCollections, where collections of attributes are associated to unique IDs, also called Indexes.
Table 3. Items, where each file, email item, web link, etc. is given a unique ID
Table 4. Item-AttributeCollection, which relates each Item to an AttributeCollection ID

One additional table is used to improve performance:
Table 5. AttributeCollectionIndex, which contains one row for each
   AttributeCollection (In the AttributeCollections table, each
   AttributeCollection ID appears once for each index in the collection of attributes)

Two additional tables are used to guide the initial navigation through a hierarchy:
Table 6. Folders, which stores the folders used to initiate navigation through the hierarchy
Table 7. Folder-Hierarchies, which stores one of the many parent-child hierarchies that can be used to initiate navigation through the attribute-based hierarchy

Finally, 2 special data elements are used to improve performance and provide an aid to navigation through a hierarchy:
In the Attribute Collection Index table, there is a hash code element that improves performance
In the Attribute Collection table, there is a relevance column that helps determine the relative importance of attributes as a user is navigating through a hierarchy

### Benefits

Using Design 4 (above), if there are 10 items each in a tree structure with 10 folders in 2 levels, the number of items in the database is 2 levels * 100 items =200 records.

In the Viapoint approach, there would be 13 indexes, and 100 index object records for a total of 113 records. This is a savings factor of almost 2×. The deeper the hierarchy becomes, the greater the savings in space. If there is another level in the hierarchy, Design 4 would add another 100 records for each level. Design 5 would only require 1 more record in each of 4 tables, for a total of 117 records, while Design 4 would require 100 additional records for a total of 300 records and a savings factor of almost 3×.

Efficient storage translates into higher performance, since the number of records that have to be stored, retrieved, and manipulated to accomplish the same results is smaller. While the computational demands of Viapoint's approach are higher, these demands are felt mostly when a user is saving an item, which occurs only once, and do not affect retrieval, which occurs many times. Viapoint gains its performance during navigation, which is when users expect and demand higher speeds.

### Detailed Design

(i) Hierarchy Creation

The following steps are used to create the hierarchy data for the Viapoint database.
1. The item is assigned a unique ID and stored in the table of Items (Table 1). For example: a Microsoft Word document, Test.doc is given Item ID 1.
2. For each folder that an item might appear in, a record is created in the Attribute table (Table 2), with a unique ID. For our example, we will have three attributes: “Company XYZ”, “Contact John Smith”, and “Project 1”, which will be assigned, respectively, unique Attributes IDs 1, 2 and 3.
3. The collection of three attributes is associated with one Unique ID in the AttributeCollection table, (Table 3). So, in our example, each of the three Attribute IDs described in step 2 are associated with a single collection, AttributeCollection 1.
4. The item, Item 1, is then associated with AttributeCollection 1 in the Item-AttributeCollection table, (Table 4).

These 4 steps complete the storage of data necessary to maintain 6 3 level hierarchies:
Company-Contact-Project
Company-Project-Contact
Contact-Company-Project
Contact-Project-Company
Project-Company-Contact
Project-Contact-Company
   as well as 6-2 level hierarchies and 3 top level folders (1 level “hierarchies”). To improve performance, each unique AttributeCollection record is stored in the AttributeCollection Index table.

To facilitate the initial navigation, a folder hierarchy is stored through the following 2 steps:
5. The Folder table (Table 6) is used to store the folders that constitute the initial hierarchy to be used for navigation.
6. The FolderHierarchy table (Table 7) contains the simple parent/child relationship that allows users to identify a single starting location and find a set of folders that are children of that location. Each “child” folder is associated with an Attribute Collection Index that then determines what folders appear in the next level of the tree.

### (ii) Hierarchy Navigation

The following steps are used to navigate a hierarchy:
1. The user starts navigating by selecting the folder of the record that has no parent in the folder hierarchy.
2. The user selects one of the child folders. This folder record is associated with an AttributeCollection, and the collection of attributes that make up that collection are used to display the next level in the hierarchy.
3. At each level, the user selects an attribute and the next level of the tree displays the attributes that have not yet been “selected” for navigation. At any point in the navigation, after the initial FolderHierarchy navigation, the user can choose any attribute to navigate. There is no implicit or explicit order to the attributes, so the user may navigate the levels of the hierarchy in any order.

At any time during navigation, it is possible to identify all items that “belong” to the current node in the hierarchy by gathering the AttributeCollections that contain the current node's attributes and finding all of the items attached to those collections. This eliminates the need for a user to navigate all of the way down a hierarchy to view items further down.

As a user navigates deeper into the hierarchy, it is possible for an item to belong to more than one of the collections at any given level. As a result, the item the user is looking for could be at the last node of any or all of the paths that the user navigates through the hierarchy.

### EXAMPLE

Assume that we have 4 persons for whom we know the Hair Color and Sex. The attributes for Sex will be Men and Women, and for hair color we will have Red Hair or Brown Hair. Assuming that we had at least one person with each characteristic, the Attribute table would contain the following data:

| Attribute ID | Attribute Name |
|---|---|
| A1 | Red Hair |
| A2 | Brown Hair |
| A3 | Men |
| A4 | Women |

For each collection of Attributes that exists among our 4 persons, we create an Attribute Collection. In our example, we have Men with Brown Hair, Men with Red Hair, and Women with Red Hair, which appear in AttributeCollection Table as:

| | Attributes in the Collection |
|---|---|
| AttributeCollectionID | [attribute value - not in table] |
| AC1 | A3 [Men] |
| AC1 | A2 [Brown Hair] |
| AC2 | A4 [Women] |
| AC2 | A1 [Red Hair] |
| AC3 | A3 [Men] |
| AC3 | A1 [Red Hair] |

For performance and programming simplicity, the AttributeCollectionIndex table contains each AttributeCollectionID once:

AttributeCollectionID
AC1
AC2
AC3

Now assuming we have the following persons (“Items”) with the characteristics as shown here:

| ItemID | Person | Description [not in table] |
|---|---|---|
| P1 | John Smith | Man with Brown Hair |
| P2 | Jane Smith | Woman with Red Hair |
| P3 | Mary Jones | Woman with Red Hair |
| P4 | Richard Jones | Man with Red Hair |

The hierarchy can be represented in the database with the following ItemAttributeCollection records:

| ItemID | AttibuteCollection |
|---|---|
| P1 | AC1 |
| P2 | AC2 |
| P3 | AC2 |
| P4 | AC3 |

To navigate the hierarchy, we can start with either the Hair Color or Sex Attribute. If we start with Hair Color, we find two Attributes for Hair Color which represent the first level in the hierarchy:
1. Brown Hair
2. Red Hair

Within the Red Hair “Folder” there are AttributeCollections that include both men and women. Within the Brown Hair folder, the only AttributeCollection is for Men. The result is that the next level in the hierarchy would appear as follows:
1. Brown Hair
   1.1. Men
2. Red Hair
   2.1. Men
   2.2. Women

And by finding the items (or in our example, persons) associated with each AttributeCollection, we can arrange the persons as follows:
1. Brown Hair
   1.1. Men
      1.1.1. John Smith
2. Red Hair
   2.1. Men
      2.1.1. Richard Jones
   2.2. Women
      2.2.1. Mary Jones
      2.2.2. Jane Smith

However, we could start with Sex and navigate the hierarchy in that order, with no difference in the data we have to store—only in the order in which we access the data.
1. Men
   1.1. Brown Hair
      1.1.1. John Smith
   1.2. Red Hair
      1.2.1. Richard Jones
2. Women
   2.1. Red Hair
      2.1.1. Mary Jones
      2.1.2. Jane Smith

### Performance Architecture

Selecting the right records from a database quickly is accomplished through the creation of indexes. A database index is like a book index—it points directly to the page where specific information can be found. In the case of the Viapoint pointers, we need mechanisms for quickly selecting attribute collection indexes that have a common group of attributes. The simplified Viapoint structure does not provide an easy way to do this, since we would have to look up each attribute collection, determine which attributes belonged to that collection, and find all of the other collections that shared those attributes. To expedite this kind of query, Viapoint maintains two hash-code columns on every attribute collection. The first hash code is created from the attributes that make up the collection. It provides an extremely fast unique key to identify a single attribute collection when all attributes that make up that collection are known. The other column is an approximate hash code that improves performance by identifying similar attribute collections from within the database. Together, these columns allow Viapoint to quickly query specific collections in the database without knowing the identifiers associated with those attribute collections.

### MODIFICATIONS

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. A method for organizing a plurality of items, comprising:
creating an item table comprising (i) a list of the items, and (ii) a unique item ID associated with each item;
creating an attribute table comprising (i) a list of the attributes associated with one or more of the items, and (ii) a unique attribute ID associated with each attribute;
for each item, identifying the set of attributes associated with that item;
creating an index table comprising (i) a list of each unique set of attributes previously identified, and (ii) a unique index ID associated with each such unique set of attributes; and
creating an item-to-index table comprising (i) a list of each item, and (ii) a unique index ID associated with that item.

2. A method according to claim 1, the method further comprising:
creating a folder in a hierarchy of folders, wherein the folder is associated with a unique attribute ID.

3. A database system, comprising:
a plurality of items to be stored in the database system;
an item table comprising (i) a list of the items, and (ii) a unique item ID associated with each item;
an attribute table comprising (i) a list of the attributes associated with one or more of the items, and (ii) a unique attribute ID associated with each attribute;
an index table comprising (i) a list of each unique set of attributes associated with the items, wherein each member of that list is associated with at least one item, and (ii) a unique index ID associated with each such unique set of attributes; and
an item-to-index table comprising (i) a list of each item, and (ii) a unique index ID associated with that item.

4. A system according to claim 3, the system further comprising:
a folder in a hierarchy of folders, wherein the folder is associated with a unique attribute ID.
